(19) United States
(12) Patent Application Publication
(10) Pub. No.: US 2005/0148753 A1
(43) Pub. Date: Jul. 7, 2005

(54) Crosslinked polyurethanes

(75) Inventors: Son Nguyen-Kim, Hemsbach (DE); Ellen Frommer, Hassbloch (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/508,764

(22) PCT Filed: Apr. 2, 2003
(86) PCT No.: PCT/EP03/03430

(30) Foreign Application Priority Data
Apr. 4, 2002 (DE) 102 14 971.2

(51) Int. Cl. C08G 18/00

(52) U.S. Cl. 528/44

(57) ABSTRACT

The invention relates to a crosslinked polyurethane comprising
A) at least one polytetrahydrofuran of the formula 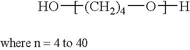 B) at least one compound which contains more than 2 active hydrogen atoms per molecule C) at least one compound which contains at least 2 active hydrogen atoms per molecule and at least one ionogenic and/or ionic group per molecule, where the groups may be anionogenic, anionic, cationogenic or cationic D) at least one diisocyanate E) optionally a compound different from B) and C) which contains at least 2 active hydrogen atoms and has a molecular weight of from 60 to 5000 or the salts thereof.

The present invention relates to crosslinked polyurethanes based on polytetrahydrofurans, and to the use thereof in cosmetic and/or pharmaceutical preparations.

In cosmetics, hair-treatment compositions which are present, for example, as hair setting compositions or hair spray, are used for setting, improving the structure of and styling the hair. The hair-treatment compositions consist primarily of a solution of film-forming resins or synthetic polymers. To date, the following film formers have mainly been used in hair-treatment compositions: shellac, homopolymers and copolymers of N-vinylpyrrolidone, copolymers of vinyl ethers/maleic half-esters, of (meth)acrylic acid or esters and amides thereof and crotonic acid with vinyl esters.

The hair-treatment compositions are applied to the hair in the form of solutions, preferably as ethanolic solutions, by spraying. After the solvent has evaporated, the hair is retained in the desired shape at the mutual points of contact by the polymer which remains. The polymers should, on the one hand, be sufficiently hydrophilic to be able to be washed out of the hair, and on the other hand they should be hydrophobic so that the hair treated with the polymers retains its shape even in high atmospheric humidity and does not stick together.

The polymeric film formers known to date, such as polyvinyl pyrrolidones, however, in most cases exhibit the disadvantage of an excessively high water absorption at increased atmospheric humidity. This property leads, inter alia, to an undesired stickiness of the hair and to a loss of the setting and thus to a collapse of the hairstyle. If, on the other hand, the resistance to high atmospheric humidity is improved, e.g. in the case of copolymers of N-vinylpyrrolidone and vinyl acetate, then the setting action of the film suffers as a result and may even lead to an unpleasant dusting and a flaky deposit. In addition, the ability to be washed out during washing of the hair, in particular, is hindered. It is an object of the present invention to provide auxiliaries for cosmetic and pharmaceutical preparations.

It is an object of the present invention to provide novel cosmetic compositions, in particular hair-treatment compositions based on polyurethane, which, on the one hand, can be used as hair-setting compositions, but, on the other hand, also have a good ability to be washed out (redispersibility). They should impart smoothness and suppleness to the hair.

Of particular interest are polymeric film formers which impart the desired flexibility to the hair and at the same time have no or low stickiness.

We have found that this object is achieved by crosslinked polyurethanes comprising
A) at least one polytetrahydrofuran of the formula 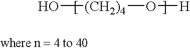
B) at least one compound which contains more than 2 active hydrogen atoms per molecule
C) at least one compound which contains at least 2 active hydrogen atoms per molecule and at least one ionogenic and/or ionic group per molecule, where the groups may be anionogenic, anionic, cationogenic or cationic
D) at least one diisocyanate.

The crosslinked polyurethanes according to the invention are suitable as cosmetic and/or pharmaceutical auxiliaries, in particular as film formers.

EP 656 021 B1 describes the use of
a) at least one compound which contains two or more active hydrogen atoms per molecule,
b) at least one acid- or salt-containing diol and
c) at least one diisocyanate
with a glass transition temperature of at least 15° C. and acid numbers of from 12 to 150, or the salts of these polyurethanes in cosmetic preparations and as binders or coverings in pharmaceutical preparations.

Examples which are mentioned are polyurethanes from polyesters. EP 656 021 B1 does not describe polyurethanes with polytetrahydrofurans.

Compared to the polyurethanes described in EP 656 021 B1, the polyurethanes according to the invention have good flexibility, coupled with low stickiness.

EP-A-619 111 describes the use of polyurethanes based on organic diisocyanates, diols and 2,2-hydroxymethyl-substituted carboxylates of the formula 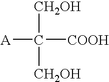
in which A is a hydrogen atom or a C₁-C₂₀-alkyl group, in hair-setting compositions. At least some of the carboxyl groups here are neutralized with an organic or inorganic base. The diols here have a molecular weight in the range from 300 to 20 000, the suitable diol component being, inter alia, also polytetrahydrofurans. However, none of the working examples describes a polyurethane based on a polytetrahydrofuran. Films based on these polyurethanes are soft and sticky and the hair-setting compositions based thereon are accordingly in need of improvement.

The polyurethanes described in the last-mentioned publications can satisfy the requirements for hair-setting polymers only partially. For example, the desired suppleness of the hair in the case of all of the abovementioned polyurethane-based products is in need of improvement.

EP 672 076 B1 describes the use of cationic polyurethanes and polyureas comprising
(a) at least one diisocyanate which may have already been reacted beforehand with one or more compounds which contain two or more active hydrogen atoms per molecule, and
(b) at least one diol containing one or more tertiary, quaternary or protonated tertiary amine nitrogen atoms, primary or secondary amino alcohol, primary or secondary diamine or primary or secondary triamine
with a glass transition temperature of at least 25° C. and an amine number of from 50 to 200, based on the nonquaternized or protonated compounds, or other salts of these polyurethanes and polyureas as auxiliaries in cosmetic and pharmaceutical preparations.

Polyurethanes containing cationic groups form hygroscopic films which are sticky. They therefore generally do not satisfy the requirements with regard to shine and natural appearance which are placed on hair-setting polymers.

WO 01/16200 describes water-soluble or water-dispersible polyurethanes comprising an oligomer a) of
A) at least one diisocyanate,
B) at least one compound with at least two groups which are reactive toward isocyanate groups and which is chosen from
   B1) aliphatic and cycloaliphatic polyoles, polyamines and/or amino alcohols,
   B2) polyetheroles and/or diaminopolyethers,
   B3) polysiloxanes with at least two active hydrogen atoms per molecule,
   B4) polyester polyoles,
   and mixtures thereof, and
C) optionally at least one dicarboxylic acid and/or hydroxycarboxylic acid,
where the oligomer contains, per molecule, at least two urethane and/or urea groups and additionally at least two further functional groups which are chosen from hydroxyl, primary and/or secondary amino groups,
and
b) at least one compound with a molecular weight in the range from 56 to 600 which contains two active hydrogen atoms per molecule,
c) at least one compound which has two active hydrogen atoms and at least one ionogenic and/or ionic group per molecule,
d) optionally at least one polymer with at least two active hydrogen atoms per molecule,
e) at least one diisocyanate.

These polyurethanes contain at least one of the oligomers as component a) in incorporated (copolymerized) form.

EP 938 889 A2 describes an aqueous cosmetic composition comprising at least one water-soluble or water-dispersible polyurethane of
a) at least one polymer with two active hydrogen atoms per molecule which is chosen from polytetrahydrofurans, polysiloxanes and mixtures thereof,
b) at least one polyesterdiol,
c) at least one compound with a molecular weight in the range from 56 to 300 which contains two active hydrogen atoms per molecule,
d) at least one compound which has two active hydrogen atoms and at least one anionogenic or anionic group per molecule,
e) at least one diisocyanate,
or the salts thereof, where the polyurethane does not contain a unit originating from a primary or secondary amine which has an ionogenic or ionic group.

The polyurethanes described in EP 938 889 A2 are essentially uncrosslinked.

In contrast thereto, the polyurethanes according to the invention are crosslinked.

None of the mentioned publications describes crosslinked polyurethanes based on polytetrahydrofurans as in claim 1.

The present invention provides a crosslinked polyurethane comprising
A) at least one poolytetrahydrofuran of the formula 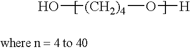
B) at least one compound which contains more than 2 active hydrogen atoms per molecule
C) at least one compound which contains at least 2 active hydrogen atoms per molecule and at least one ionogenic and/or ionic group per molecule, where the groups may be anionogenic, anionic, cationogenic or cationic
D) at least one diisocyanate
or the salts thereof.

Component A) is a polytetrahydrofuran of the formula

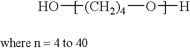

These polytetrahydrofurans usually have a number-average molecular weight in the range from 200 to 3000, preferably 250 to 2000, in particular 600 to 1500.

Suitable polytetrahydrofurans can be prepared by cationic polymerization of tetrahydrofuran in the presence of acidic catalysts, such as, for example, sulfuric acid or fluorosulfuric acid. Such preparation processes are known to the person skilled in the art.

Component B) is a compound which contains more than 2 active hydrogen atoms per molecule.

Compounds suitable as component B) are those with more than 2 OH and/or NH groups. Compounds with 3 to 20, in particular 3 to 10, especially 3 to 5, OH and/or NH groups are particularly suitable.

As component B), preference is given to using triols and higher polyols having 3 to 100, preferably 3 to 70, carbon atoms. Examples of preferred triols are glycerol and trimethylolpropane. Preferred triols B) are also the triesters of hydroxycarboxylic acids with trivalent alcohols. The compounds are preferably triglycerides of hydroxycarboxylic acids, such as, for example, lactic acid, hydroxystearic acid and ricinoleic acid. Also suitable are naturally occurring mixtures which contain hydroxycarboxylic acid triglycerides, in particular castor oil. Preferred higher polyols B) are, for example, erythritol, pentaerythritol and sorbitol.

Preferred triamines B) are, for example, diethylenetriamine, N,N′-diethyldiethylenetriamine etc. Preferred higher polyamines are, for example triethylenetetramine etc. and α,ω-diaminopolyethers, which can be prepared by amination of polyalkylene oxides with ammonia.

The compounds specified as component B) can be used individually or in mixtures.

As component B), it is also possible to use polysiloxanes with more than 2 active hydrogen atoms.

The polysiloxanes B) are, for example compounds of the formula II 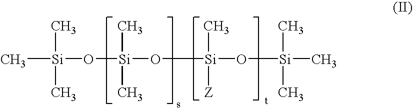
in which
the order of the siloxane units is arbitrary,
s is a value from 5 to 200, preferably 10 to 100,
Z is a radical of the formula (Z-I) ═—(CH₂)ᵤ₋NH₂, in which u is an integer from 1 to 10, preferably 2 to 6,
and/or
Z is a radical of the formula (Z-II) ═—(CH₂)ₓ—NH—(CH₂)_{y}—NH₂, in which x and y, independently of one another, are 0 to 10, preferably 1 to 6, while the sum of x and y is 1 to 10, preferably 2 to 6,
t is a value from 3 to 20, preferably of 3 to 10, if Z=Z-I
t is a value from 2 to 20, preferably of 2 to 10, is Z=Z-II

These include, for example, the MAN and MAR products from Huls, and the Finish products from Wacker, e.g. Finish WT 1270.

Particularly suitable polyalkylene oxide-containing silicone derivatives are those which contain the following structural elements: 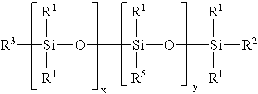
where x and y are integers such that the molecular weight of the polysiloxane is between 300 and 30 000,
and where the radicals R¹ may be identical or different and originating either from the group of aliphatic hydrocarbons having 1 to 20 carbon atoms, are cyclic aliphatic hydrocarbons having 3 to 20 carbon atoms, or are aromatic in nature
and where the radicals R², R³, R⁵ may be identical or different and originate either from the group of aliphatic hydrocarbons having 1 to 20 carbon atoms, are cyclic aliphatic hydrocarbons having 3 to 20 carbon atoms, or are aromatic in nature or are equal to R⁶, where: 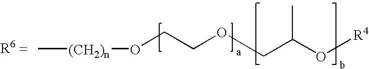
with the proviso that at least one of the radicals R², R³ or R⁵ is a polyalkylene oxide-containing radical in accordance with the above definition for R⁶ and n is an integer from 1 to 6, in particular n=3,
a, b may be integers between 0 and 50 with the proviso that the sum of a and b is greater than 0, where

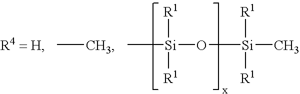

Preferably, the groups R¹ are chosen from the following group: ethyl, ethyl, propyl, butyl, isobutyl, pentyl, isopentyl, hexyl, octyl, decyl, dodecyl and octadecyl, cycloaliphatic radicals, specifically cyclohexyl, aromatic groups, specifically phenyl or naphthyl, mixed aromatic-aliphatic radicals, such as benzyl or phenylethyl, and tolyl and xylyl.

Particular preference is given to methyl, ethyl and phenyl.

Preferably, the groups R², R³ and R⁵ are chosen from the following group: methyl, ethyl, propyl, butyl, isobutyl, pentyl, isopentyl, hexyl, octyl, decyl, dodecyl and octadecyl, cycloaliphatic radicals, specifically cyclohexyl, aromatic groups, specifically phenyl or naphthyl, mixed aromatic-aliphatic radicals, such as benzyl or phenylethyl, and tolyl and xylyl and R⁶.

Preferred radicals R² and R⁶ are those in which the sum of a+b is between 5 and 30.

In a particularly preferred embodiment of the present invention, the polyalkylene oxide-containing silicone derivative B) used is a compound of the following formula: 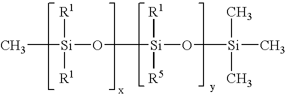
where
R¹═—CH₃ 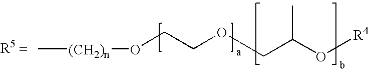
R⁴═—H; —COCH₃, alkyl with C₁-C₄, —OH
n=1 to 6, in particular 2 to 4, preferably 3,
where y is chosen so that at least 3 OH groups are present in the molecule, i.e. when 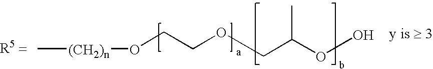
x and y are integers such that the molecular weight of the polysiloxane block is between 1000 and 10 000,
a, b may be integers between 0 and 50, with the proviso that the sum of a and b is greater than 0.

As component B), it is also possible to use silicone-containing polyamino compounds.

These are preferably a diaminopolyether siloxane of the formula IV which is chosen from
polysiloxanes with repeat units of the formula IV.I 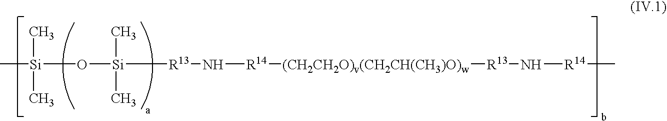
   in which
a is an integer from 0 to 100,
b is an integer from 2 to 8,
R¹³ and R¹⁴, independently of one another, are C₁- to C₈-alkylene,
the order of the alkylene oxide units is arbitrary and v and w, independently of one another, are an integer from 0 to 200, where the sum of v and w is >0,
polysiloxanes of the formula IV.2 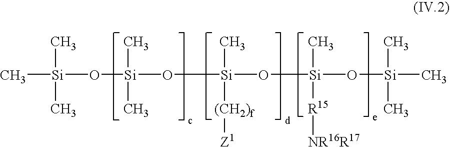
   in which
R¹⁵ is a C₁- to C₈-alkylene radical,
R¹⁶ and R¹⁷, independently of one another, are hydrogen, C₁- to C₈-alkyl or C₅- to C₈-cycloalkyl, the order of the siloxane units is arbitrary, c, d and e, independently of one another are 0 to 100, where the sum of c, d and e is at least 3, and where d and e are chosen so that at least 3 active hydrogen molecules are present,
f is an integer from 2 to 8,
Z¹ is a radical of the formula V
   —R¹⁸—(CH₂CH₂O)_{g}(CH2CH(CH₃)O)ₕ—H (V)
   in which
the order of the alkylene oxide units is arbitrary and g and h, independently of one another, are an integer from 0 to 200, where the sum of g and h is >0,
R¹⁸ is a C₁- to C₈-alkylene radical
   and mixtures thereof.

Polysiloxanes of the formula IV.2 with more than 2 active hydrogen atoms are those in which d is ≧3 when R¹⁶ and R¹⁷≠H; or d+e is ≧3 when R¹⁶, R¹⁷═H.

Preferably, in the formula IV.1, R¹³ and R¹⁴, independently of one another, are a C₂- to C₄-alkylene radical. In particular, R¹³ and R¹⁴, independently of one another, are a C₂- to C₃-alkylene radical.

Preferably, the molecular weight of the compound of the formula IV.1 is in a range from about 300 to 100 000.

Preferably, in the formula IV.1, a is an integer from 1 to 20, such as, for example 2 to 10.

The total number of alkylene oxide units in the compound of the formula IV.1, i.e. the sum of v and w, is preferably in a range from about 3 to 200, preferably 5 to 180.

The end-groups of the polysiloxanes with repeat units of the formula IV.1 are preferably chosen from (CH₃)₃SiO, H, C₁- to C₈-alkyl and mixtures thereof.

Suitable alkoxylated siloxaneamines of the formula IV.1 are described, for example, in WO-A-97/32917, to the entire contents of which reference is hereby made. Commercially available compounds are, for example, the Silsoft® products from Witco, e.g. Silsoft® A-843.

Preferably, in the formula IV.2, the radical R¹⁵ is a C₂- to C₄-alkylene radical.

Preferably, in the formula IV.2, R¹⁶ and R¹⁷, independently of one another, are hydrogen or C₁- to C₄-alkyl.

Preferably, the sum of c, d and e is chosen so that the molecular weight of the compound of the formula IV.2 is in a range from about 300 to 100 000, preferably 500 to 50 000.

The total amount of the alkylene oxide units of the radical of the formula V, i.e. the sum of g and h, is preferably in a range from about 3 to 200, preferably 5 to 80.

Preferably, in the formula V, the radical R¹⁸ is C₂- to C₄-alkyl.

Preferably, in the formula V, the radical R¹⁹ is hydrogen or C₁- to C₄-alkyl.

A suitable compound of the formula IV.2 is, for example, Silsoft® A-858 from Witco.

Component C) is a compound which has at least 2 active hydrogen atoms and at least one ionogenic and/or ionic group per molecule, where the groups may be anionogenic, anionic, cationogenic and/or cationic.

Preferred compounds C) with two active hydrogen atoms and at least one anionogenic and/or anionic group per molecule are, for example, compounds with carboxylate and/or sulfonate groups. As component C), 2,2-hydroxymethylalkylcarboxylic acids, such as dimethylolpropanoic acid, and mixtures which contain 2,2-hydroxymethylalkylcarboxylic acids, such as dimethylolpropanoic acid, are particularly preferred.

Suitable diamines and/or diols C) with anionogenic or anionic groups are compounds of the formula 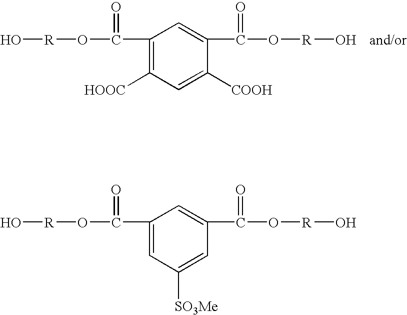
in which R is in each case a C₂-C₁₈-alkylene group and Me is Na or K.

As component C), it is also possible to use compounds of the formula
H₂N (CH₂)_{w}—NH—(CH₂) ₓ—COO⁻M⁺
H₂N (CH₂)_{w}—NH—(CH₂) x—SO₃⁻M⁺
in which w and x, independently of one another, are an integer from 1 to 8, in particular 1 to 6, and M is Li, Na or K, and compounds of the formula
H₂N(CH₂CH₂O)_{y}(CH₂CH(CH₃)O)_{z}(CH₂)_{w}—NH—(CH₂)ₓ—SO₃⁻M⁺
in which w and x have the meanings given above, y and z, independently of one another, are an integer from 0 to 50, where at least one of the two variables y or z is >0. The order of the alkylene oxide units here is arbitrary. The last-mentioned compounds preferably have a number-average molecular weight in the range from about 400 to 3000. A suitable compound of this type is, for example, Poly ESP 520 from Raschig.

The polyurethanes can also contain, in each incorporated form, compounds C) which have two active hydrogen atoms and at least one cationogenic and/or cationic group, preferably at least one nitrogen-containing group, per molecule. The nitrogen-containing group is preferably a tertiary amino group or a quaternary ammonium group. Preference is given, for example, to compounds of the formulae 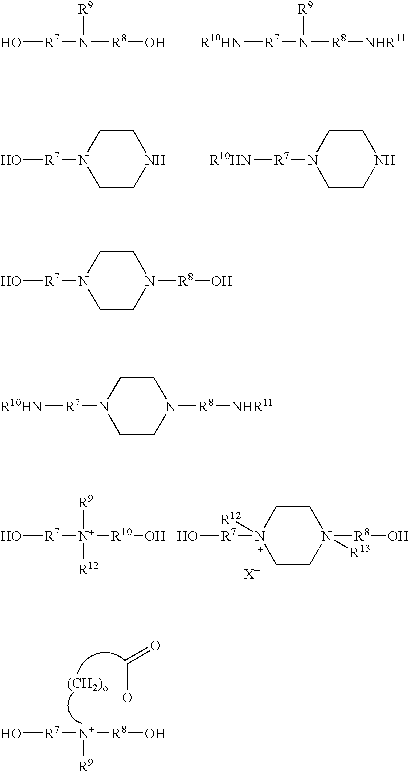
in which
R⁷ and R⁸, which may be identical or different, are C₂-C₈-alkylene,
R⁹, R¹² and R¹³, which may be identical or different, are C₁-C₆-alkyl, phenyl or phenyl-C₁-C₄-alkyl,
   R¹⁰ and R¹¹, which may be identical or different, are H or C₁-C₆-alkyl,
   ₒ is 1, 2 or 3,
   X⁷³ is chloride, bromide, iodide, C₁-C₆-alkyl sulfate or SO₄²⁻/₂.

Particular preference is given to using N—(C₁- to C₆-alkyl)diethanolamines, such as methyldiethanolamine, and N-alkyldialkylene triamines, such as N-methyldipropylene triamine. These are preferably used in combination with dimethylolpropanoic acid as component C).

Also suitable as component C) are mixtures which comprise two or more of the abovementioned compounds with anionic and/or anionogenic groups, two or more of the abovementioned compounds with cationic and/or cationogenic groups or mixtures which comprise at least one of the abovementioned compounds with anionic or anionogenic groups and at least one of the abovementioned compounds with cationic or cationogenic groups. Preference is given, for example, to using mixtures which comprise dimethylolpropanoic acid and N-methyldiethanolamine. According to a preferred embodiment, the polyurethanes comprise predominantly or exclusively anionogenic and/or anionic groups as ionogenic and/or ionic groups. According to a further preferred embodiment, the polyurethanes comprise predominantly or exclusively cationogenic and/or cationic groups as ionogenic and/or ionic groups. Preferably, the polyurethanes thus comprise, in incorporated form, a component C) which comprises predominantly, preferably in an amount of at least 80% by weight, in particular in an amount of at least 90% by weight, based on the total amount of component C), either anionogenic (anionic) compounds or cationogenic (cationic) compounds.

The diisocyanates D) are preferably chosen from aliphatic, cycloaliphatic and/or aromatic diisocyanates, such as tetramethylene diisocyanate, hexamethylene diisocyanate, methylenediphenyl diisocyanate, 2,4- and 2,6-tolylene diisocyanate and isomeric mixtures thereof, o-, m- and p-xylylene diisocyanate, 1,5-naphthylene diisocyanate, 1,4-cyclohexylene diisocyanate, dicyclohexylmethane diisocyanate and mixtures thereof, in particular isophorone diisocyanate, hexamethylene diisocyanate and/or dicyclohexylmethane diisocyanate. Particular preference is given to using hexamethylene diisocyanate. If desired, up to 3 mol % of said compounds can be replaced by triisocyanates.

Component E) is a compound different from B) and C) which contains at least 2 active hydrogen atoms and has a molecular weight of from 60 to 5000.

As component E), preference is given to using diols whose molecular weight is in a range from about 62 to 500 g/mol. These include, for example, diols having 2 to 18 carbon atoms, preferably 2 to 10 carbon atoms, such as 1,2-ethanediol, 1,3-propanediol, 1,4-butanediol, 1,6-hexanediol, 1,5-pentanediol, 1,10-decanediol, 2-methyl-1,3-propanediol, 2,2-dimethyl-1,3-propanediol, di-, tri-, tetra-, penta- and hexaethylene glycol, neopentyl glycol, cyclohexanedimethylol and mixtures thereof.

Preferred amino alcohols E) are, for example, 2-aminoethanol, 2-(N-methylamino)ethanol, 3-aminopropanol, 4-aminobutanol, 1-ethylaminobutan-2-ol, 2-amino-2-methyl-1-propanol, 4-methyl-4-aminopentan-2-ol etc.

Preferred polyamines E) are, for example, diamines, such as ethylenediamine, propylenediamine, 1,4-diaminobutane, 1,5-diaminopentane and 1,6-diaminohexane.

The compounds known as component E) can be used individually or in mixtures. Particular preference is given to using 1,2-ethanediol, 1,4-butanediol, 1,6-hexanediol, neopentyl glycol, diethylene glycol, cyclohexanedimethylol and mixtures thereof.

Component E) is preferably a polymer with a number-average molecular weight in the range from about 300 to 5000, preferably about 400 to 4000, in particular 500 to 3000. Polymers E) which can be used are, for example, polyesterdiols, polyetherols, polysiloxanes and mixtures thereof. Polyetherols are preferably polyalkylene glycols, e.g. polyethylene glycols, polypropylene glycols etc., copolymers of ethylene oxide and propylene oxide or block copolymers of ethylene oxide, propylene oxide and butylene oxide which contain the copolymerized alkylene oxide units in random distribution or in the form of blocks. Also suitable are α,ω-diaminopolyethers which can be prepared by amination of polyalkylene oxides with ammonia. Preference is given to using polyesterdiols and mixtures which contain these as component E).

Preferred polyesterdiols have a number-average molecular weight in the range from about 400 to 5000, preferably 500 to 3000, in particular 600 to 2000.

Suitable polyesterdiols are all those which are customarily used for the preparation of polyurethanes, in particular those based on aromatic dicarboxylic acids, such as terephthalic acid, isophthalic acid, phthalic acid, Na or K sulfoisophthalic acid etc., aliphatic dicarboxylic acids, such as adipic acid or succinic acid etc., and cycloaliphatic dicarboxylic acids, such as 1,2-, 1,3- or 1,4-cyclohexanedicarboxylic acid. Suitable diols are, in particular, aliphatic diols, such as ethylene glycol, propylene glycol, 1,6-hexanediol, neopentyl glycol, diethylene glycol, polyethylene glycols, polypropylene glycols, 1,4-dimethylolcyclohexane.

Preference is given to polyesterdiols based on aromatic and aliphatic dicarboxylic acids and aliphatic diols, in particular those in which the aromatic dicarboxylic acid constitutes 10 to 95 mol %, in particular 40 to 90 mol %, of the total dicarboxylic acid fraction (remainder aliphatic dicarboxylic acids).

Particularly preferred polyesterdiols are the reaction products of phthalic acid/diethylene glycol, isophthalic acid/1,4-butanediol, isophthalic acid/adipic acid/1,6-hexanediol, 5-NaSO₃-isophthalic acid/phthalic acid/adipic acid/1,6-hexanediol, adipic acid/ethylene glycol, isophthalic acid/adipic acid/neopentyl glycol, isophthalic acid/adipic acid/neopentyl glycol/diethylene glycol/dimethylolcyclohexane and 5-NaSO₃-isophthalic acid/isophthalic acid/adipic acid/neopentyl glycol/diethylene glycol/dimethylolcyclohexane, isophthalic acid/adipic acid, neopentyl glycol/dimethylolcyclohexane.

Also preferred as component E) are polyesterdiols based on linear or branched C₈- to C₃₀-di- or polycarboxylic acids and C₈- to C₃₀-hydroxycarboxylic acids. Preferred carboxylic acids and hydroxycarboxylic acids are, for example, azelaic acid, dodecanedioic acid, suberic acid, pimelic acid, sebacic acid, tetradecanedioic acid, citric acid, ricinoleic acid, hydroxystearic acid and mixtures thereof. The diol component used for the preparation of these polyesterdiols is preferably 1,4-butanediol, 1,5-pentanediol, 1,6-hexanediol, neopentyl glycol, 1,4-dimethylolcyclohexane, diethylene glycol and mixtures thereof.

As component E), it is also possible to use polysiloxanes of the following formula 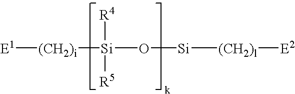
in which
R⁴ and R⁵, independently of one another are C₁- to C₄-alkyl, benzyl or phenyl,
E¹ and E², independently of one another are OH or NHR⁶, where R⁶ is hydrogen, C₁- to C₆-alkyl or C₅- to C₈-cycloalkyl,
i and l, independently of one another, are 2 to 8,
k is 3 to 50,
and mixtures thereof.

Suitable alkyl radicals are, for example, methyl, ethyl, n-propyl, isopropyl, n-butyl, t-butyl, n-pentyl, n-hexyl etc. Suitable cycloalkyl radicals are, for example, cyclopentyl, cyclohexyl, cycloheptyl, cyclooctyl etc.

Preferably, R⁴ and R⁵ are both methyl.

These polysiloxanes E) preferably have a number-average molecular weight in the range from about 300 to 10 000, preferably 400 to 5 000.

Suitable compounds E) are also the polydimethylsiloxanes described in EP-A-227 816, to which reference is hereby made.

Preferably, only one of components B) or E) comprises a polysiloxane.

Preference is given to crosslinked polyurethanes comprising
15 to 50% by weight, in particular 20 to 35% by weight of A)
0.1 to 5% by weight, in particular 0.2 to 2% by weight of B)
8 to 20% by weight, in particular 10 to 15% by weight of C)
25 to 60% by weight, in particular 30 to 50% by weight of D)
0 to 15% by weight, in particular 0 to 10% by weight of E)

Very particular preference is given to crosslinked polyurethanes comprising
20 to 25% by weight of A)
0,5 to 1.5% by weight of B)
10 to 15% by weight of C)
40 to 50% by weight of D)
0 to 2% by weight of E)

Particular preference is given to crosslinked polyurethanes comprising
A) polytetrahydrofuran, in particular with a molecular weight of from 200 to 3000, preferably 250 to 2000, particularly preferably from 600 to 1500
B) trimethylolpropane (TMP)
C) dimethylolpropanoic acid (DPMA)
D) at least one diisocyanate, preferably hexamethylene diisocyanate and/or isophorone diisocyanate
E) optionally neopentyl glycol.

The polyurethanes used in the compositions according to the invention are prepared by reacting the compounds of components A), B), C), D) and optionally E). The temperature is in a range from about 60 to 140° C., preferably about 70 to 100° C. The reaction can be carried out without solvents or in a suitable inert solvent or solvent mixture. Suitable solvents are aprotic-polar solvents, e.g. tetrahydrofuran, ethyl acetate, N-methylpyrrolidone, dimethylformamide and preferably ketones, such as acetone and methyl ethyl ketone. The reaction is preferably carried out under an inert gas atmosphere, such as, for example, under nitrogen. The components are used in amounts such that the ratio of NCO equivalent of the compounds of component E) to equivalent of active hydrogen atom of components A), B), C) and D) is in a range from about 0.8:1 to 1.25:1, preferably 0.85:1 to 1.2:1, in particular 1.05:1 to 1.15:1. If the resulting polyurethanes still have free isocyanate groups, then these are finally deactivated by adding amines, preferably amino alcohols. Suitable amino alcohols are those described previously as component C), preferably 2-amino-2-methyl-1-propanol.

The acid-containing polyurethanes can be converted into a water-soluble or water-dispersible form by partial or complete neutralization with a base.

The resulting salts of the polyurethanes generally have a better solubility in water or dispersibility in water than the unneutralized polyurethanes. The bases used for the neutralization of the polyurethanes may be alkali metal bases, such as sodium hydroxide solution, potassium hydroxide solution, soda, sodium hydrogen carbonate, potassium carbonate or potassium hydrogen carbonate and alkaline earth metal bases, such as calcium hydroxide, calcium oxide, magnesium hydroxide or magnesium carbonate, and ammonia and amines. Suitable amines are, for example, C₁-C₆-alkylamines, preferably n-propylamine and n-butylamine, dialkylamines, preferably diethylpropylamine and dipropylmethylamine, trialkylamines, preferably triethylamine and triisopropylamine, C₁-C₆-alkyldiethanolamines, preferably methyl- or ethyldiethanolamine and di-C₁-C₆-alkylethanolamines. Particularly for use in hair-treatment compositions, 2-amino-2-methyl-1-propanol, diethylaminopropylamine and triisopropanolamine have proven useful for the neutralization of the acid-containing polyurethanes. The neutralization of the acid-containing polyurethanes can also be undertaken using mixtures of two or more bases, e.g. mixtures of sodium hydroxide solution and triisopropanolamine. Depending on the intended use, the neutralization may be partial, e.g. to 20 to 40%, or complete, i.e. to 100%.

If a water-miscible organic solvent is used in the preparation of the polyurethanes, then this can be subsequently removed by customary methods known to the person skilled in the art, e.g. by distillation at reduced pressure. Prior to the removal of the solvent, water may additionally be added to the polyurethane. Replacing the solvent with water gives a solution or dispersion of the polymer from which, if desired, the polymer can be isolated in the usual manner, e.g. by spray drying.

The polyurethanes according to the invention have K values (measured in accordance with E. Fikentscher, Cellulose-Chemie 13 (1932), pp. 58-64, on a 1% strength solution in N-methylpyrrolidone) in a range from 15 to 90, preferably 20 to 60. Their glass transition temperature is generally at least 0° C., preferably at least 20° C., especially preferably at least 25° C. and specifically at least 30° C.

The polyurethanes according to the invention are particularly suitable as coatings for keratin-containing surfaces (hair, skin and nails). If the polyurethanes according to the invention are dispersible in water, they can be applied in the form of aqueous microdispersions with particle diameters of usually 1 to 150 nm, preferably 5 to 100 nm. The solids contents of the preparations are usually in a range from about 0.5 to 20% by weight, preferably 1 to 12% by weight. These microdispersions do not generally require any emulsifiers or surfactants for their stabilization.

Preferably, the polyurethanes according to the invention can be in the form of a hair-treatment composition, in particular in the form of a hair spray. For use as hair-setting compositions, preference is given here to compositions which comprise polyurethanes whose glass transition temperature T_{g} is ≧20° C., preferably ≧30° C. The K value of these polymers is preferably in a range from 23 to 90, in particular 25 to 60.

The cosmetic compositions generally comprise the polyurethanes in an amount in the range from 0.2 to 20% by weight, based on the total weight of the composition.

The compositions are preferably hair-treatment compositions. These are usually in the form of an aqueous dispersion or in the form of an alcoholic or aqueous-alcoholic solution. Examples of suitable alcohols are ethanol, propanol, isopropanol etc.

The invention provides a hair cosmetic composition comprising
0.5 to 20% by weight of a crosslinked polyurethane as claimed in any of the preceding claims
40 to 99% by weight, preferably 50 to 98% by weight, of at least one solvent chosen from water, water-miscible solvents and mixtures thereof
0 to 50% by weight of a propellant.

In addition, the hair-treatment compositions generally comprise customary cosmetic auxiliaries, for example softeners, such as glycerol and glycol; emollients; perfumes; UV absorbers; dyes; thickeners; antistats; agents for improving combability; preservatives; and foam stabilizers.

If the polyurethanes according to the invention are formulated as hair spray, they comprise an adequate amount of a propellant, for example a low-boiling hydrocarbon or ether, such as propane, butane, isobutane or dimethyl ether. Propellants which can be used are also compressed gases, such as nitrogen, air or carbon dioxide. The amount of propellant here may be kept low in order not to unnecessarily increase the VOC content. It is then generally not more than 55% by weight, based on the total weight of the composition. If desired, however, higher VOC contents of 85% by weight and above are also possible.

The polyurethanes described above can also be used in combination with other hair polymers in the compositions. Such polymers are, in particular:
nonionic, water-soluble or water-dispersible polymers or oligomers, such as polyvinylcaprolactam, e.g.. Luviskol Plus (BASF), or polyvinylpyrrolidone and copolymers thereof, in particular with vinyl esters, such as vinyl acetate, e.g. Luviskol VA 37 (BASF); polyamides, e.g. based on itaconic acid and aliphatic diamines;
amphoteric or zwitterionic polymers, such as the octylacrylamide/methyl methacrylate/tert-butylaminoethyl methacrylate/2-hydroxypropyl methacrylate copolymers obtainable under the names Amphomer® (Delft National), and zwitterionic polymers, as are disclosed, for example, in German patent applications DE 39 29 973, DE 21 50 557, DE 28 17 369 and DE 37 08 451. Acrylamidopropyltrimethylammonium chloride/acrylic acid or
methacrylic acid copolymers and alkali metal and ammonium salts thereof are preferred zwitterionic polymers. Further suitable zwitterionic polymers are methacroylethylbetaine/methacrylate copolymers, which are commercially available under the name Amersette® (AMERCHOL);
anionic polymers, such as vinyl acetate/crotonic acid copolymers, as are available commercially, for example under the names Resyn® (NATIONAL STARCH), Luviset® (BASF) and Gafset® (GAF), vinylpyrrolidone/vinyl acrylate copolymers, obtainable, for example, under the trade name Luviflex® (BASF). A preferred polymer is the vinylpyrrolidone/acrylate terpolymer obtainable under the name Luviflex® VBM-35 (BASF), acrylic acid/ethyl acrylate/N-tert-butylacrylamide terpolymers, which are sold, for example, under the name Ultrahold® strong (BASF), and Luvimer® (BASF, terpolymer of t-butyl acrylate, ethyl acrylate and methacrylic acid), or
cationic (quaternized) polymers, e.g. cationic polyacrylate copolymers based on N-vinyllactams and derivatives thereof (N-vinylpyrrolidone, N-vinylcaprolactam etc.), and customary cationic hair-conditioning polymers, e.g. Luviquat® (copolymer of vinylpyrrolidone and vinylimidazolium methochloride), Luviquat® Hold (copolymer of quaternized N-vinylimidazole, N-vinylpyrrolidone and N-vinylcaprolactam), Merquat® (polymer based on dimethyldiallylammonium chloride), Gafquat® (quaternary polymers which arise by reacting polyvinylpyrrolidone with quaternary ammonium compounds), polymer JR (hydroxyethylcellulose with cationic groups), polyquaternium products (CTFA names) etc.;
nonionic, siloxane-containing, water-soluble or -dispersible polymers, e.g. polyether siloxanes, such as Tegopren® (Goldschmidt) or Belsil® (Wacker).

The inventive crosslinked polyurethanes based on at least one polytetrahydrofuran are preferably used as the mixture with one other amide-containing hair polymer. These include, for example, the polyurethanes described in DE-A-42 25 045, the above-described vinylpyrrolidone/acrylate terpolymers and acrylic acid/ethyl acrylate/N-tert-butylacrylamide terpolymers (e.g. Ultrahold® strong from BASF Aktiengesellschaft), the above-described amide-containing amphoteric polymers (e.g. Amphomer®) and, in particular, copolymers which have a content of amide-containing monomers, such as N-vinyllactams, of at least 30% by weight (e.g. Luviskol® plus and Luviskol® VA37 from BASF Aktiengesellschaft). Particular preference is given to mixtures of the polyurethanes with these amide-containing hair polymers.

The other hair polymers are preferably present in amounts up to 10% by weight, based on the total weight of the composition.

A preferred hair-treatment composition comprises:
a) 0.5 to 20% by weight of at least one crosslinked polyurethane as claimed in claim 1,
b) 40 to 99% by weight, preferably 50 to 98% by weight, of a solvent chosen from water and water-miscible solvents, preferably C₂- to C₅-alcohols, in particular ethanol, and mixtures thereof,
c) 0 to 50% by weight of a propellant, preferably dimethyl ether,
d) 0 to 15% by weight of at least one water-soluble or -dispersible hair polymer different from a),
e) 0 to 0.2% by weight of at least one water-insoluble silicone,
f) 0 to 2% by weight of at least one nonionic, siloxane-containing, water-soluble or -dispersible polymer.

The composition according to the invention can comprise, as component d), at least one other water-soluble or -dispersible hair polymer. The content of this component is then generally about 0.1 to 15% by weight, preferably 0.1 to 10% by weight, based on the total amount of the composition. Preference may be given here to using crosslinked polyurethanes which do not contain any copolymerized siloxane groups.

The composition according to the invention can comprise, as component e), at least one water-insoluble silicone, in particular a polydimethylsiloxane, e.g. the Abil® product from Goldschmidt. The content of this component is then generally about 0.001 to 0.2% by weight, preferably 0.01 to 0.1% by weight, based on the total weight of the composition.

The composition according to the invention can comprise, as component f), at least one nonionic, siloxane-containing, water-soluble or -dispersible polymer, in particular chosen from the above-described polyether siloxanes. The content of this component is then generally about 0.001 to 2% by weight, based on the total weight of the composition.

The composition according to the invention can optionally additionally comprise a defoamer, e.g. based on silicone. The amount of defoamer is generally up to about 0.001% by weight, based on the total amount of the composition.

A particularly preferred hair-treatment composition comprises:
a) 0.5 to 20% by weight of at least one crosslinked polyurethane as claimed in claim 1,
b) 50 to 98% by weight of a solvent chosen from water, ethanol and mixtures thereof,
c) 0 to 50% by weight of a propellant,
d) 0.1 to 10% by weight of at least one water-soluble or -dispersible, amide-containing, silicone-free hair polymer,
e) 0 to 0.1% by weight of at least one water-insoluble silicone,
f) 0 to 1% by weight of at least one nonionic, siloxane-containing, water-soluble or -dispersible polymer
and customary additives.

In a preferred embodiment, the amide-containing hair polymer d) is a polymer which contains one or more copolymerized amide-containing monomers. Preferred amide-containing monomers are N-vinyllactams, which are preferably chosen from N-vinylpyrrolidone, N-vinylcaprolactam, derivatives thereof, which may, for example, have one or more C₁- to C₄-alkyl substituents, and mixtures thereof. The hair polymers d) comprise these then preferably in an amount of at least 30% by weight in copolymerized form. Also suitable is a polymer mixture which has at least one such copolymer. Particular preference is given to the Luviskol® products from BASF Aktiengesellschaft, such as Luviskol VA37 and Luviskol plus.

According to a further preferred embodiment, the amide-containing hair polymer d) is a silicone-free polyurethane, as are described, for example, in DE-A-42 25 045, DE-A-42 41 118 and EP-A-619 111.

The compositions according to the invention have the advantage that, on the one hand, they impart the desired setting to the hair and, on the other hand, the polymers can be readily washed out (are redispersible), and they additionally make the hair smooth and/or shine. Moreover, hair-treatment compositions with a VOC content of less than 85% by weight, preferably less than 60% by weight, and also purely aqueous formulations, can be prepared even if they are formulated as hair spray.

The above inventive crosslinked polyurethanes of a polytetrahydrofuran and/or polysiloxane are also suitable as auxiliaries in pharmacy, such as, for example, as coatings and/or binders for solid medicament forms. They can also be used in creams and as tablet coatings and tablet binders. Furthermore, they are suitable for use as coatings for the textile, paper, printing, leather and adhesive industries.

### EXAMPLES

### Example 8

In a reaction vessel equipped with stirrer, dropping funnel, thermometer, reflux condenser and equipment for working under nitrogen, 500 g [0.5 mol] of polytetrahydrofuran (Mn=1000 g/mol), 26.8 (0.2 mol) of trimethylolpropane (TMP), 201 g (1.5 mol) [lacuna], 228 g (2.2 mol) of neopentyl glycol (NPG) and 268 g (2 mol) of dimethylolpropanoic acid (DMPA) were dissolved in 370 g of methyl ethyl ketone with heating to a temperature of 80° C. and with stirring. As soon as everything had dissolved, the reaction mixture was cooled to about 50° C. Then, with stirring, a mixture of 588 g (3.5 mol) of hexamethylene diisocyanate and 333 g (1.5 mol) of isophorone diisocyanate were added dropwise, during which the reaction temperature increased. Under reflux, the reaction mixture was then stirred until the NCO content of the mixture remained virtually constant. The mixture was then cooled to RT. The reaction product was terminated and 90% neutralized with 161.3 g (1.8 mol) of 2-amino-2-methyl-1-propanol (AMP)/water at a temperature of about 40° C. The solvent was then distilled off under reduced pressure at 40° C., giving an aqueous dispersion. Pulverulent polyurethanes can be obtained by spray drying.

Examples 1 to 13 were prepared accordingly.

The table below gives the composition and the performance properties.

Examples 1 to 5 are comparative examples,

Examples 6 to 13 are in accordance with the invention.

TABLE

| | | | | | | | | | | | Flexibility grade | |
|---|---|---|---|---|---|---|---|---|---|---|---|---|
| | P(ester- | PEG | P(THF) | A-Si | | | | | | | (with AMP-neutralized | Sticki- |
| | diol) | 1000 | 1000 | 2122 | TMP | HDI | NPG | DMPA | MDEA | IPDI | prod.) | ness |
| 1 | 1.0 | — | — | — | — | — | 1.2 | 2.5 | — | 5 | 3 | 1 |
| 2 | 1.0 | — | — | — | — | 3 | 1.2 | 2.5 | — | 2 | 2 | 1 |
| 3 | 0.5 | 0.5 | — | — | — | 5 | 1.2 | 2.5 | — | — | 1 | 2-3 |
| 4 | — | 0.5 | 0.5 | — | — | 3 | 1.2 | 2.5 | — | 2 | 1 | 2-3 |
| 5 | — | — | 0.5 | — | — | 4 | 2.2 | 2.5 | — | 1 | 1 | 1-2 |
| 6 | — | 0.3 | 0.7 | — | 0.3 | 3 | 1.2 | 2.5 | — | 1.7 | 1 | 1-2 |
| 7 | — | — | 0.5 | — | 0.3 | 4 | 1.8 | 2.5 | — | 1 | 1 | 1 |
| 8 | — | — | 0.5 | — | 0.2 | 3.5 | 2.2 | 2.0 | — | 1.5 | 1 | 1 |
| 9 | — | — | 0.5 | — | 0.2 | 3.5 | 2.2 | 1.7 | 0.3 | 1.5 | 1 | 1 |
| 10 | 0.1 | — | 0.4 | — | 0.2 | 3.5 | 2.2 | 2.0 | — | 1.5 | 1 | 1 |
| 11 | — | 0.1 | 0.4 | — | 0.2 | 3.5 | 2.2 | 2.0 | — | 1.5 | 1 | 1 |
| 12 | — | — | 0.45 | 0.05 | 0.2 | 3.5 | 2 | 2.2 | — | 1.5 | 1 | 1 |
| 13 | — | 0.5 | 0.5 | — | 0.2 | 3 | 1.2 | 2.5 | — | 2 | 1 | 1 |

P(Ester-diol): Polyesterdiol of isophthalic acid/adipic acid/hexanediol(1,6) MW ≈ 1000 g/mol
PEG 1000: Polyethylene glycol, MW ≈ 1000 g/mol
P(THF)1000: Polytetrahydrofuran, MW ≈ 1000 g/mol
A-Si2122: P(Dimethylsiloxanediamine), Mn ≈ 900 (Tegomer, Goldschmidt)
NPG: Neopentyl glycol
DMPA: Dimethylolpropanoic acid
HDI: Hexamethyldiisocyanate
IPDI: Isophorone diisocyanate
AMP: Amino-2-methylpropanol
MDEA: N-Methyldiethanolamine
TMP: Trimethylolpropane

Performance Investigations

The flexibility was determined by measuring the modulus of elasticity

Flexibility grade=modulus of elasticity (N/mm²):

| | |
|---|---|
| 1: very flexible | modulus of elasticity ≦ 200 N/mm² |
| 2: flexible | modulus of elasticity = 200 to 800 N/mm² |
| 3: moderately flexible | modulus of elasticity = 800 to about |
| | 1400 N/mm² (can still be measured) |
| 4: brittle | (films with layer thickness of about 100 |
| | to 150 μm) cannot be punched out; cannot |
| | be measured |

The stickiness was determined as follows.

A film (about 30 μm film layer thickness) was applied to a glass plate and stored overnight at 40° C. and 75% relative atmospheric humidity. The stickiness of the film was determined by a panel of experts.
Grade 1=not sticky
Grade 2=slightly sticky
Grade 3=sticky
   Formulations

In order to demonstrate the use as hair-treatment compositions, the following hair-treatment compositions were prepared:

| (a) Aerosol hairspray (purely ethanolic) | |
|---|---|
| Polyurethane as in Example 7 | 3.00% |
| 2-Amino-2-methylpropanol | 0.26% |
| Ethanol abs. | 61.74% |
| Dimethyl ether | 35.00% |
| (b) Aerosol hairspray (aqueous-alcoholic) | |
| Polyurethane as in Example 7 | 3.00% |
| 2-Amino-2-methylpropanol | 0.26% |
| Water dist. | 10.00% |
| Ethanol abs. | 51.74% |
| Dimethyl ether | 35.00% |
| (c) Hand pump spray | |
| Polyurethane as in Example 7 | 6.00% |
| 2-Amino-2-methylpropanol | 0.52% |
| Water dist. | 93.48% |
| (d) Hair-setting composition (purely aqueous) | |
| Polyurethane as in Example 7 | 4.00% |
| 2-Amino-2-methylpropanol | 0.37% |
| Water dist. | 95.63% |
| (e) Hair-setting composition (aqueous-alcoholic) | |
| Polyurethane as in Example 7 | 4.00% |
| 2-Amino-2-methylpropanol | 0.37% |
| Water dist. | 63.75% |
| Ethanol abs. | 31.88% |

1. A crosslinked polyurethane comprising
A) at least one polytetrahydrofuran of the formula 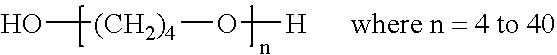
B) at least one compound which contains more than 2 active hydrogen atoms per molecule
C) at least one compound which contains at least 2 active hydrogen atoms per molecule and at least one ionogenic and/or ionic group per molecule, where the groups may be anionogenic, anionic, cationogenic or cationic
D) at least one diisocyanate
E) optionally a compound different from B) and C) which contains at least 2 active hydrogen atoms and has a molecular weight of from 60 to 5000 or a salt thereof.

2. A crosslinked polyurethane as claimed in claim 1, where the polytetrahydrofuran A) has a molecular weight of from 200 to 3000, preferably 250 to 2000.

3. A crosslinked polyurethane as claimed in claim 1, where triols and/or triamines are used as component B).

4. A crosslinked polyurethane as claimed in claim 1 further comprising
15 to 50% by weight, in particular 20 to 35% by weight, of A)
0.1 to 5% by weight, in particular 0.2 to 2% by weight, of B)
8 to 20% by weight, in particular 10 to 15% by weight, of C)
25 to 60% by weight, in particular 30 to 50% by weight, of D)
0 to 15% by weight, in particular 0 to 10% by weight of E)
with the proviso that the components add up to 100%.

5. A crosslinked polyurethane as claimed in claim 1 further comprising
A) polytetrahydrofuran, in particular with a molecular weight of from 200 to 3000, preferably 250 to 2000, particularly preferably from 600 to 1500.
B) trimethylolpropane (TMP)
C) dimethylolpropanoic acid (DPMA)
D) at least one diisocyanate, preferably hexamethylene diisocyanate and/or isophorone diisocyanate.
E) optionally neopentyl glycol.

6. A hair cosmetic composition comprising
0.5 to 20% by weight of a crosslinked polyurethane as claimed in claim 1
40 to 99% by weight, preferably 50 to 98% by weight, of at least one solvent chosen from water, water-miscible solvents and mixtures thereof
0 to 50% by weight of a propellant.

7. A method for producing cosmetic and/or pharmaceutical auxiliaries comprising adding a crosslinked polyurethane as claimed in claim 1 to a cosmetic and/or pharmaceutical auxiliaries formulation.

8. A method as claimed in claim 7 wherein said cosmetic and/or pharmaceutical auxiliaries are film formers.

9. A method for producing a coating, covering and/or binder for solid medicament forms comprising adding a crosslinked polyurethane as claimed in claim 1 to a coating, covering and/or binder for solid medicament forms.

10. A method for producing a coating comprising adding a crosslinked polyurethane as claimed in claim 1 to a coating formulation wherein said coating is utilized in the textile, paper, printing, leather and adhesive industries.
